(19) United States
(12) Patent Application Publication
(10) Pub. No.: US 2011/0267431 A1
(43) Pub. Date: Nov. 3, 2011

(54) METHOD AND APPARATUS FOR DETERMINING THE 3D COORDINATES OF AN OBJECT

(75) Inventors: Marcus Steinbichler, Neubeuern (DE); Bertram Kaupert, Oberaudorf (DE)

(73) Assignee: Steinbichler Optotechnik GmbH, Neubeuern (DE)

(21) Appl. No.: 13/096,384

(22) Filed: Apr. 28, 2011

(30) Foreign Application Priority Data
May 3, 2010 (DE) 102010018979.0

(51) Int. Cl. H04N 13/02

(52) U.S. Cl. 348/46; 348/E13.074

(57) ABSTRACT

In a method of determining the 3D coordinates of the surface (1) of an object (2), the surface (1) of the object (2) is scanned by a scanner (3) for acquiring object data. The position and orientation of the scanner (3) for acquiring positional data are determined, in particular by a tracking system (4). The object data and the positional data are transferred to a controller (5) which determines the 3D coordinates of the surface (1) of the object (2) from them. To improve such a method, the object data are wirelessly transmitted from the scanner (3) to the controller (5).

### BACKGROUND OF THE INVENTION

The invention relates to a method for determining the 3D coordinates of the surface of an object and to an apparatus for the carrying out of such a method.

In the method, the surface of the object is scanned by a scanner for the gaining of object data. Such a scanner is known from EP 1 724 549 A2 to which reference is herewith made. The scanner can in particular be a line scanner. The scanner can include a projection device for projecting a pattern onto the object. The projection device in particular projects a line onto the object. The pattern or the line is preferably projected onto the object by coherent light, in particular laser light. The scanner can furthermore include a camera which is suitable to detect the pattern projected onto the object, in particular the line projected onto the object. The camera can include an imaging optics and a sensor, in particular an areal sensor, in particular a CCD sensor or a CMOS sensor or another sensor.

The object data which are taken by the scanner relate to the reference system of this scanner. It is, however, necessary to obtain absolute 3D coordinates of the surface of the object, that is, 3D coordinates of the surface of the object which are present in a spatially fixed coordinate system. It is necessary for this purpose to determine the position and orientation of the scanner. In this manner, the positional data of the scanner can be maintained which make it possible to convert the object data present in the coordinate system of the scanner into absolute 3D coordinates of the surface of the object.

The object data and the positional data are transferred to a controller which determines the 3D coordinates of the surface of the object from them. These 3D coordinates are absolute coordinates, that is, coordinates in a spatially fixed reference system.

A method in accordance with the background of the invention is known from EP 0 553 266 B1. This method can in particular be used in the inspection of the dimensional accuracy of components, for example in the production and monitoring of pressing tools for manufacturing body sheets of vehicles. It is used by automobile manufacturers, in aircraft construction, and in the consumer sector.

The object data have previously been transferred to the controller by the scanner through a line, in particular an electric or optical line. Multi-core cables can be used for this purpose, for example a one to 36-core cable which establishes the connection between the scanner and the controller. Such a cable comes with various disadvantages. It can be caught in the measuring setup, it can become twisted and it can present a risk of stumbling for the operator. With sensitive object surfaces, for example of clay models, it can occur that the cable touches the surface during measurement and damages it by pressure marks. The limited length of the cable of, for example, 10 m can in particular prevent the measurement of large objects in one piece and make it necessary to have to move the object or the whole measuring device. Cables are sensitive to small bending radii and kinking points or pressure points, whereby breaks in the cable shielding or even individual strands can occur in regions under high strain.

### SUMMARY OF THE INVENTION

It is the object of the invention to provide an improved method and an improved apparatus of the initially named kind.

This object is achieved in accordance with the invention in a method for determining the 3D coordinates of a surface of an object by the features herein. The object data are transmitted wirelessly from the scanner to the controller. The carrying out of the method is hereby simplified. The disadvantages associated with a cable do not occur. The weight of the scanner acting on the cable can in particular be saved. A wireless transfer of the object data can take place by radio waves or by an optical transfer, in particular by infrared radiation.

Advantageous further developments are described herein.

It is advantageous if the object data and the positional data are synchronized with one another. To be able to determine the 3D coordinates of the surface of the object with sufficient precision, it is necessary that the 3D coordinates are calculated from object data and positional data which have each been determined at the same time. The time difference of these data from one another may not exceed a specific limit to ensure sufficient precision of the 3D coordinates determined therefrom. A time offset of only a few microseconds can already effect a noticeable data offset which can result in substantially degraded or unusable measurement data.

It is advantageous if the object data and the positional data are synchronized by a wireless transfer. The object data and the positional data are preferably synchronized recurringly, in particular regularly recurrently. The wireless transfer can take place by radio waves or by an optical transfer, in particular by infrared radiation. A separate transfer channel can be used for the wireless transfer of the synchronization.

A further advantageous further development is characterized in that the controller and/or the scanner generates a synchronization signal which is wirelessly transmitted to the controller and/or to the scanner. The synchronization signal can therefore be generated by the controller which wirelessly transfers it to the scanner. Instead or additionally, the synchronization signal can be generated by the scanner which wirelessly transfers it to the controller. A clock can in particular be integrated in the controller which wirelessly synchronizes a preferably high-resolution timer which is provided in the scanner. A common starting time for the taking and/or the transmission of the object data and for the taking and/or the transmission of the associated positional data can be defined by the synchronization. This can be effected by switching on and/or switching off the signal of the clock (clock signal) and/or b a separate signal of a trigger (trigger signal).

It is advantageous if the object data are compressed before the wireless transmission to the controller. Since the transmission of the object data from the scanner to the controller takes place wirelessly, the data transmission rate is restricted in relationship to a transmission through a line. With a wired transmission, it is in particular possible to use a plurality of parallel lines, whereby the data transmission capacity can be increased. It can accordingly be advantageous or necessary to compress the object data and thereby to reduce the data quantity to be transmitted.

The reduction in the data quantity can take place in the scanner or in a signal transmission unit present in the scanner. The reduction of the data quantity to be transmitted can take place in a manner such that the useful data can be extracted from the measured raw data. The useful data can in particular be the coordinates of the points on the areal sensor which correspond to the points of the line projected onto the object.

The scanner can be a component of a coordinate measuring machine. In this case, the stationary coordinate measuring machine delivers the positional data for the position of the scanner. The scanner can be supported and can be movable in three axes in the coordinate measuring machine. The coordinate measuring machine can transmit the coordinates of the position of the scanner. The scanner can furthermore be pivotable.

It is advantageous in this case if the coordinate measuring machine also transmits the data of the orientation of the scanner determined by the pivoting. It is, however, also possible that the scanner is rigidly fastened, that is, not pivotably, to the coordinate measuring machine. In this case, the orientation of the scanner is determined by the fixedly installed orientation.

The scanner can be provided at an articulated arm or at an arm of an industrial robot. The articulated arm can be an articulated arm guided by hand. It is, however, also possible that the articulated arm is driven by one or more motors, in particular by electric motors. In all cases, the positional data for the position and orientation of the scanner are determined from the angles of the joints and from the lengths of the arms of the articulated arm or of the industrial robot.

It is particularly preferred if the scanner is a hand-held scanner. It is advantageous in this case if the position and orientation of the scanner are determined by a tracking system. Examples for such tracking systems are described in EP 0 553 266 B1 and in EP 1 724 549 A2 to which reference is herewith made.

A further advantageous further development is characterized in that the energy supply of the scanner takes place by an energy supply unit which can be carried on the person. The energy supply unit preferably includes batteries and/or rechargeable batteries. The energy supply unit can also supply further apparatus with energy, in particular a transmitter for the wireless transmission of the object data to the controller.

In accordance with a further advantageous further development, errors in the transmission of the object data are automatically recognized and remedied. It can hereby be prevented that object data not detected or transmitted, or not correctly detected or transmitted, due, for example, to interference signals from the environment, have to be taken again with a corresponding additional effort and corresponding additional costs. There are furthermore cases in which measurements cannot be repeated because the measurement object or the measuring device are no longer available. Errors can in particular be remedied in that data or data packets not transmitted, or not transmitted correctly, are transmitted again.

The apparatus in accordance with the invention for determining the 3D coordinates of the surface of an object, in particular for carrying out the method in accordance with the invention, includes a scanner for acquiring object data of the surface of the object, an apparatus for determining the position and orientation of the scanner for acquiring positional data and a controller for determining the 3D coordinates of the surface of the object from the object data and the positional data. In accordance with the invention, the apparatus includes a transmission device for the wireless transmission of the object data from the 3D measuring device to the controller.

It is advantageous if the apparatus includes a synchronization device for synchronizing the object data with the positional data and/or a wireless transmission device for the synchronization device and/or a signal preparation device for compressing the object data before the wireless transmission to the controller and/or a hand-held scanner and/or a tracking system for determining the position and/orientation of the scanner and/or an energy supply unit which can be carried on the person for the energy supply of the scanner and/or an error elimination device for the automatic recognition and remedying of errors on the transmission of the object data.

The invention further relates to a coordinate measuring machine or to an articulated arm or to an industrial robot which are characterized by an apparatus in accordance with the invention.

### BRIEF DESCRIPTION OF THE DRAWINGS

An embodiment of the invention will be explained in detail in the following with reference to the enclosed drawing. There are shown in the drawing

FIG. 1 an apparatus for determining the 3D coordinates of the surface of an object in a schematic perspective view;

FIG. 2 the canner in accordance with FIG. 2 in a schematic perspective view;

FIG. 3 the CMOS sensor of the scanner in accordance with FIG. 2 in an enlarged view;

FIG. 4 the intensity curve along the column, shown by dashed lines, of the CMOS sensor in FIG. 3; and

FIG. 5 a signal curve of the object data, of the positional data and of the synchronization signal.

### DESCRIPTION OF THE PREFERRED EMBODIMENTS

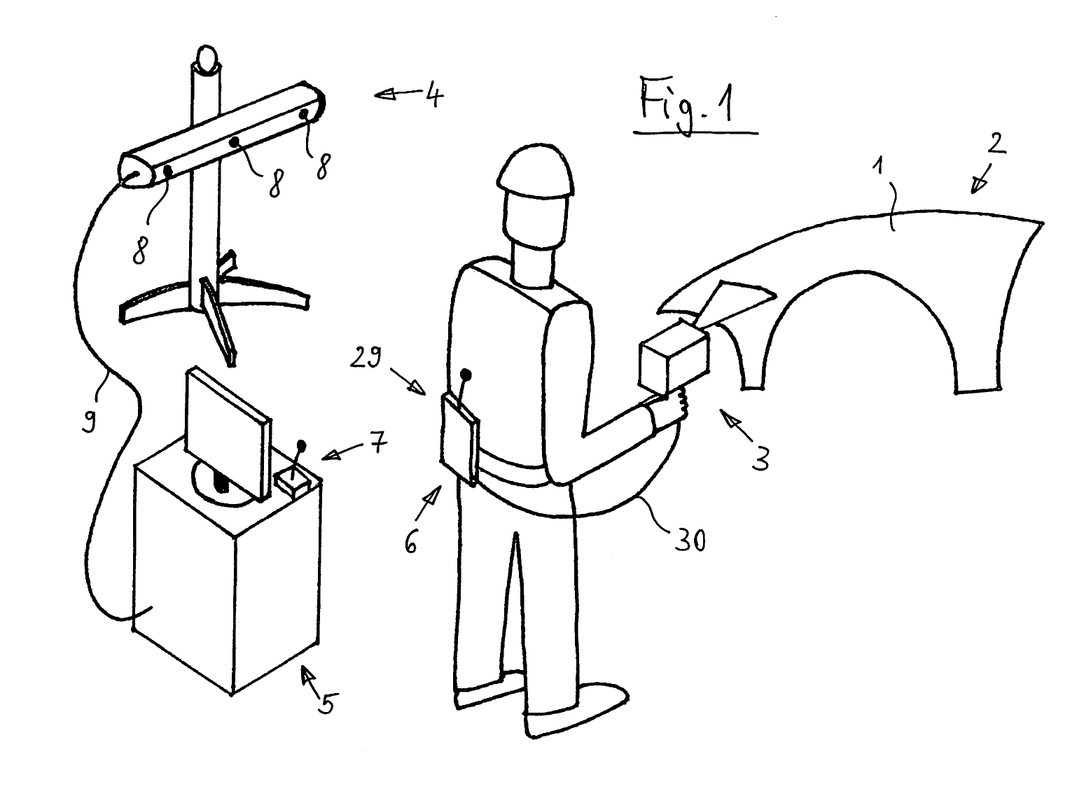

The apparatus shown in FIG. 1 for determining the 3D coordinates of the surface 1 of an object 2, namely of a fender of a motor vehicle, includes a scanner 3 for acquiring the object data of the surface 1 of the object 2, a tracking system 4 for determining the position and orientation of the scanner 3 and for acquiring the positional data of the scanner 3 and a controller 5 for determining the 3D coordinates of the surface 1 of the object 2 from the object data and from the positional data. The apparatus further includes a transmission device for the wireless transmission of the object data from the scanner 3 to the controller 5, said transmission device including a transceiver 6 and a transceiver 7. A bidirectional data transfer takes place between the transceivers 6, 7. The transceiver 7 of the controller 5 transmits commands to the scanner 3.

A plurality of detectors, in particular IR detectors (infrared detectors), are arranged (not shown in the drawing) at the scanner 3 and their positions are determined by the tracking system 4. The tracking system 4 determines the position and the orientation of the scanner 3 from the positions of the IR detectors. For this purpose, the tracking system 4 includes three IR sensors (infrared sensors) which each include an optics and a CCD sensor. The IR detectors of the scanner 3 are controlled and activated alternately so that their signals are picked up by the IR sensors 8, from which the tracking system 4 determines the respective position of the respectively controlled IR detector. The tracking system 4 determines the position and orientation of the scanner 3 from this and transmits these positional data of the scanner 3 via the line 9 to the controller 5. It is, however, also possible that the positional data of the scanner 3 are determined by the controller 5. The controller 5 includes a data processing device, in particular a PC.

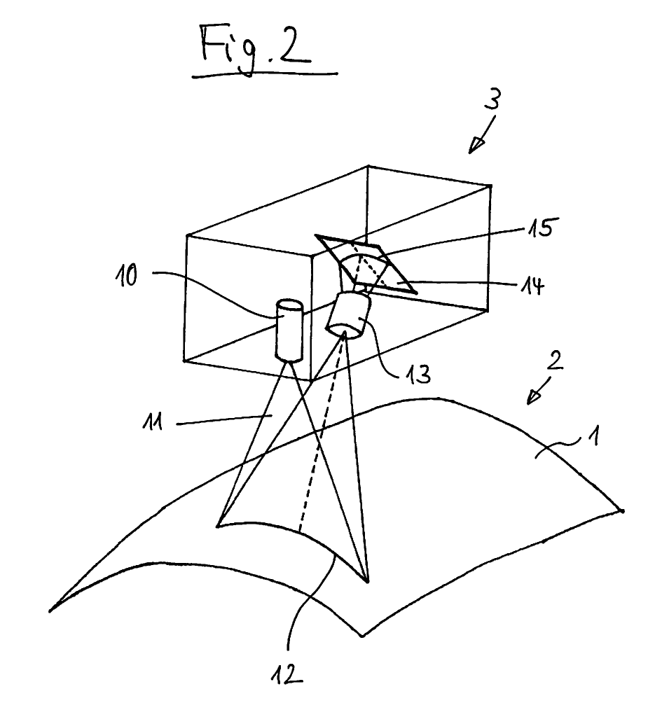

The scanner 3 is shown in detail in FIG. 2. It includes a projector 10 which has a laser light source and a line optics. The projector 10 projects an areal light cone 11 onto the surface 1 of the object 2 on which surface a projection line 12 is hereby produced.

This projection line 12 is taken by a camera 13 of the scanner 3, said camera including a camera optics and a CMOS sensor 14 which is shown exaggeratedly large in FIG. 2. The projection line 12 is imaged as a sensor line 15 on to the CMOS sensor 14 in the camera 13. The data of the CMOS sensor 14 form the object data.

The hand-held scanner 3 is moved along the object 2. In this manner, the projection line 12 sweeps over the surface 1 of the object 2. In so doing, data sets are created which are associated with the respective position of the scanner 3 at a specific point in time. The data set for a specific position of the scanner 3 at a specific point in time includes the sensor line 15 which belongs to the projection line 12 taken at this point in time and the position and orientation of the scanner 3 at this point in time, which are determined by the tracking system 4. The 3D coordinates of the projection line 12 on the surface 1 of the object 2 can be determined from this data set. The 3D coordinates for a plurality of projection lines 12 and thus for the total surface 1 of the object 2 can be determined by a repetition of this procedure and by the processing of a plurality of data sets for other positions of the scanner 3 at other points in time.

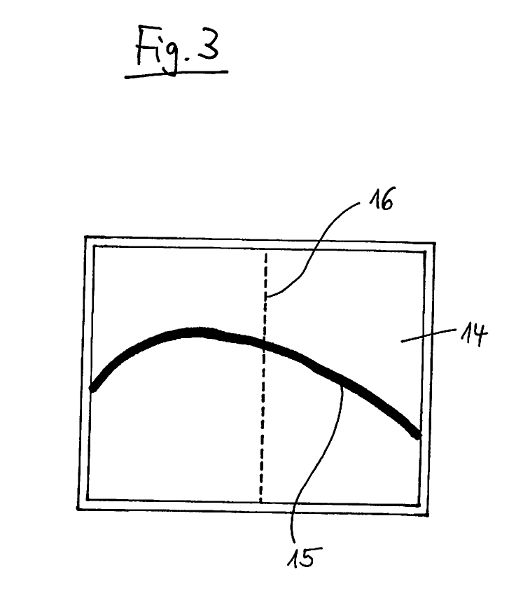

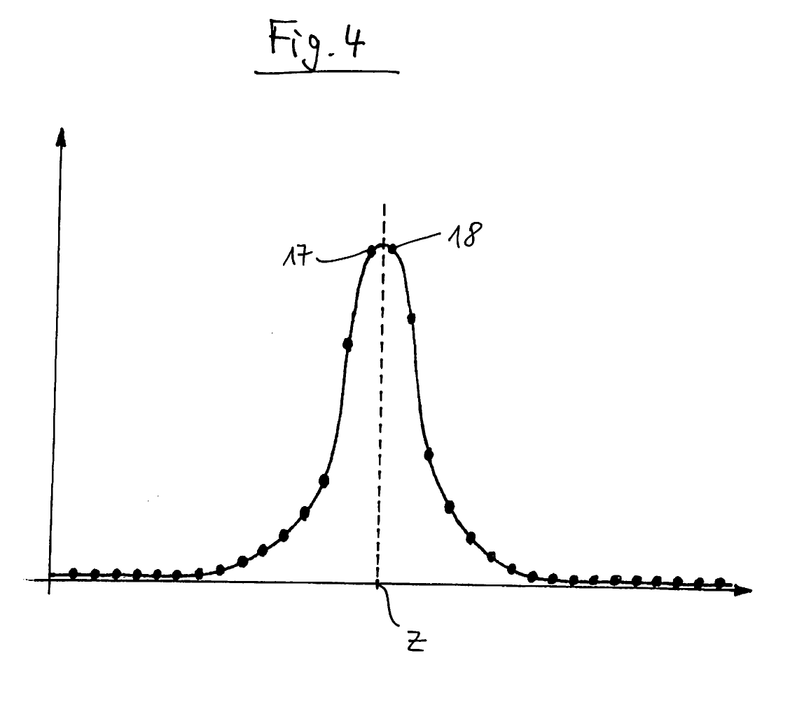

The object data are compressed in the scanner 3 before the wireless transmission to the controller 5. A possible compression procedure is explained in the following with reference to FIGS. 3 and 4. The pixels of the CMOS sensor 14 are evaluated column-wise in this process. The dashed line 16 symbolizes the column of the CMOS sensor 14 which is just being evaluated. This line 16 is run through from the top to the bottom. In so doing, the pixels of the associated column of the CMOS sensor are read out. The intensities of the read out values are shown in FIG. 4 in which the spacing from the upper edge of the CMOS sensor 14 is entered on the horizontal axis and the intensity measured on the respective pixel is entered on the vertical axis. Starting at the upper edge of the CMOS sensor 14, measurement values having a low intensity are read out first. The maximum intensity values 17, 18 achieved in the following show the position of the point of the sensor line 15 lying on the line 16. In this manner, the row coordinate z of the sensor line 15 can be determined which belongs to the column coordinate of the line 16. This process is carried out for all columns of the CMOS sensor 14 one after the other. In this manner, the coordinates of the sensor line 15 are obtained. These coordinates are then wirelessly transmitted to the controller 5. The compression of the object data comprises that not all intensity data of all pixels of the CMOS sensor 15 have to be transmitted, but rather only the data of the coordinates of the sensor line 15.

It can be desirable or required to synchronize the object data and the positional data with one another for determining the 3D coordinates of the surface 1 of the object 2. This takes place by a wireless transmission. The controller 5 generates a synchronization signal which is transmitted by the transceiver 7 of the controller 5 to the transceiver 6 of the scanner 3.

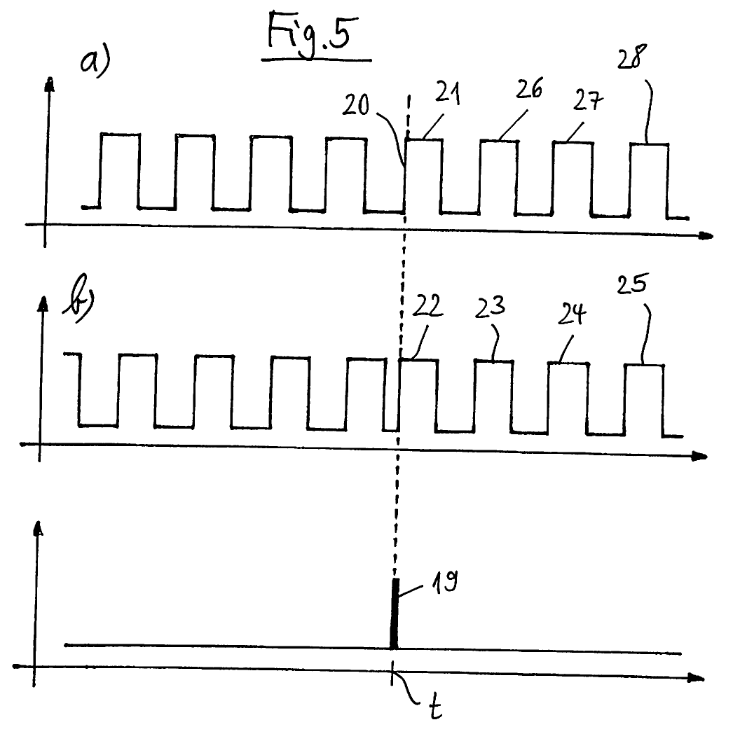

The process of synchronization is shown schematically in FIG. 5. FIG. 5a shows the time curve of the transmission of positional data, that is, of data of the position and orientation of the scanner 3, to the controller 5. FIG. 5b shows the time curve of the wireless transmission of object data from the scanner 3 to the controller 5. These data transmissions are not synchronous with one another. A synchronization signal 19 is generated by a clock in the controller 5 at a specific point in time t. The synchronization signal 19 is transmitted wirelessly to the scanner 3. A separate data transmission channel can be provided for this purpose. The point in time t coincides with the point in time of the rising flank 20 of the transmission of a packet 21 of positional data. The transmission of the synchronization signal 19 to the scanner 3 has the effect that the transmission of the next data package 22 of object data starts at the point in time of the transmission of the synchronization signal 19. The synchronization pulse 19 furthermore has the effect that a timer present in the scanner 3 is reset. This timer runs at the same speed as a corresponding timer of the controller 5. It clocks the transmission of the following data packets 23, 24, 25 of the object data at the same points in time as the timer of the controller 5 clocks the following data packets 26, 27, 28 of the positional data. This is shown to the right of the point in time t in FIG. 5.

After the transmission of a specific number of data packets, the object data and the positional data can become asynchronous again, in particular due to small differences of the speeds of the timers of the scanner 3 and of the controller 5. The data transmission can again be synchronized by a further synchronization signal.

Synchronization signals are preferably transmitted at specific, regularly recurring points in time.

The energy supply for the scanner 3 and for the transceiver 6 is provided in an energy supply unit 29 which can be carried on the person. It includes one or more heavy duty batteries. The energy supply unit 29 is connected to the scanner 3 by a line 30.

1. A method of determining the 3D coordinates of the surface (1) of an object (2), wherein
the surface (1) of the object (2) is scanned by a scanner (3) for acquiring object data;
the position and orientation of the scanner (3) is determined for acquiring positional data;
the object data and the positional data are transmitted to a controller (5) which determines the 3D coordinates of the surface (1) of the object (2) from them, and
the object data are transmitted (6, 7) wirelessly from the scanner (3) to the controller (5).

2. A method in accordance with claim 1, wherein the object data and the positional data are synchronized with one another.

3. A method in accordance with claim 2, wherein the object data and the positional data are synchronized by a wireless transmission.

4. A method in accordance with claim 2, wherein the controller (5) and/or the scanner (3) generates a synchronization signal (19) which is wirelessly transmitted to the controller (5) and/or to the scanner (3).

5. A method in accordance with claim 1, wherein the object data are compressed before the wireless transmission to the controller (5).

6. A method in accordance with claim 1, wherein the scanner (3) is a component of a coordinate measuring machine.

7. A method in accordance with claim 1, wherein the scanner (3) is provided at an articulated joint or at an arm of an industrial robot.

8. A method in accordance with claim 1, wherein the scanner (3) is a hand-held scanner (3).

9. A method in accordance with claim 8, wherein the position and orientation of the scanner (3) are determined by a tracking system (4).

10. A method in accordance with claim 1, wherein the energy supply of the scanner (3) takes place by an energy supply unit (29) which can be carried on the person.

11. A method in accordance with claim 1, wherein errors are automatically recognized and remedied on the transmission of the object data.

12. An apparatus for determining the 3D coordinates of the surface of an object, comprising
a scanner (3) for acquiring object data of the surface (1) of the object (2);
an apparatus for determining the position and orientation of the scanner (3) for acquiring positional data;
a controller (5) for determining the 3D coordinates of the surface (1) of the object (2) from the object data and the positional data; and
a transmission device (6, 7) for the wireless transmission of the object data from the scanner (3) to the controller (5).

13. An apparatus in accordance with claim 12, comprising a synchronization device for synchronizing the object data with the positional data and/or a wireless transmission device for the synchronization device and/or a signal preparation device for compressing the object data before the wireless transmission to the controller (5) and/or a hand-held scanner (3) and/or a tracking system (4) for determining the position and/orientation of the scanner (3) and/or an energy supply unit (29) which can be carried on the person for the energy supply of the scanner (3) and/or an error elimination device for the automatic recognition and remedying of errors on the transmission of the object data.

14. A coordinate measuring machine or an
articulated arm or an industrial robot, comprising an apparatus in accordance with claim 12.

15. A coordinate measuring machine or an articulated arm or an industrial robot, comprising an apparatus in accordance with claim 12.

16. A method in accordance with claim 2, wherein the controller (5) and/or the scanner (3) generates a synchronization signal (19) which is wirelessly transmitted to the controller (5) and/or to the scanner (3).

17. A method in accordance with claim 16, wherein the object data are compressed before the wireless transmission to the controller (5).

18. A method in accordance with claim 4, wherein the object data are compressed before the wireless transmission to the controller (5).

19. A method in accordance with claim 3, wherein the object data are compressed before the wireless transmission to the controller (5).

20. A method in accordance with claim 2, wherein the object data are compressed before the wireless transmission to the controller (5).
